(19) United States
(12) Patent Application Publication
(10) Pub. No.: US 2015/0091539 A1
(43) Pub. Date: Apr. 2, 2015

(54) HALF-BRIDGE GATE DRIVER CONTROL

(71) Applicant: Infineon Technologies Autria AG, Villach (AT)

(72) Inventor: Karl Norling, Villach (AT)

(73) Assignee: Infineon Technologies Autria AG, Villach (AT)

(21) Appl. No.: 14/044,562

(22) Filed: Oct. 2, 2013

(51) Int. Cl. H02M 3/158

(52) U.S. Cl. CPC H02M 3/158
USPC 323/271

(57) ABSTRACT

A power circuit is described that includes a half-bridge and a driver for controlling a first switch of the half-bridge. The driver is configured to cause the first switch to transition between operating in an on-state of the first switch and an off-state of the first switch based at least in part on a driver signal and a voltage at the half-bridge.

### TECHNICAL FIELD

This disclosure relates to power converters, and more particular, to techniques for controlling a half-bridge of a power converter.

### BACKGROUND

Some circuits may use power converters to convert (e.g., step-up or step-down) an input voltage or current from a power source to a regulated output voltage or current for powering a component, a circuit, or other electrical device. Switch-based power converters may use half-bridge circuits and signal modulation techniques to regulate an output. In some examples, voltage overshoots can occur over a switch of a half-bridge when the switch is turned-on or -off, for example due to parasitic inductances. To compensate for voltage overshoots that may appear across a switch, in some examples, converters may include extra resistors in the power converter to reduce the rate at which current through a switch changes and/or to reduce the rate at which voltage across a switch changes. In other examples, a converter may also or instead include higher rated switch devices that can handle higher voltage levels. Some power converters may also or instead utilize constant slow turn-on times and/or constant slow turn-off times to reduce the rate at which current through a switch changes and/or to reduce the rate at which voltage across a switch changes. These aforementioned techniques for compensating for voltage overshoots may increase the cost of the power converter and/or decrease overall efficiency of the power converter.

### SUMMARY

In general, techniques and circuits are described for dynamically controlling the transition time of a switch (e.g., the amount of time needed by the switch to transition between operating in an off-state and an on-state) of a half-bridge of a power converter based at least in part on a voltage at the half-bridge in response to detected feedback. For example, a power converter as described herein may be configured to modify a rate of change of voltage over time (dv/dt) across a switch, or a rate of change of current (di/dt) through a switch, in response to at least one feedback signal detected by the power converter. In some examples, such a detected feedback signal may comprise an input voltage of a power converter. In other examples, other feedback may be used to dynamically control the transition time of a switch.

A power converter, whether a step-down or step-up converter, may include a half-bridge coupled to an input port for receiving an input voltage from a power source. The half-bridge may have at least one switch coupled to a switching node. The power converter may use signal modulation techniques to turn the switch on and/or off to convert the input voltage into a regulated output voltage and/or current at an output node coupled to the half-bridge. According to the techniques described herein, a power converter may modify the drive strength used to control the transition time of a switch of the half-bridge based on a voltage level at the half-bridge. By modifying the drive strength and the transition time of a switch based at least in part on the voltage at the half-bridge, the power converter can limit potential overshoot conditions that may occur at the half-bridge.

In one example, the disclosure is directed to a power converter including a half-bridge that includes a first switch coupled to a second switch at a switching node. The power converter further includes a driver for controlling the first switch, wherein the driver is coupled to the first switch and configured to cause the first switch to transition between operating in an on-state of the first switch and an off-state of the first switch based at least in part on a driver signal and a voltage at the half-bridge.

In another example, the disclosure is directed to a method that includes detecting a voltage at a half-bridge of a power converter, wherein the half-bridge includes a first switch coupled to a second switch at a switching node. The method further includes receiving a driver signal for controlling the first switch and the second switch. The method further includes controlling the first switch of the half-bridge based at least in part on the voltage at the half-bridge and the driver signal, wherein controlling the first switch includes causing the first switch to transition between operating in an on-state of the first switch and an off-state of the first switch.

In another example, the disclosure is directed to a power converter having means for detecting a voltage at a half-bridge of the power converter, wherein the half-bridge includes a first switch coupled to a second switch at a switching node. The power converter further has means for receiving a driver signal for controlling the first switch and the second switch. The power converter further has means for controlling the first switch of the half-bridge based at least in part on the voltage at the half-bridge and the driver signal, wherein the means for controlling the first switch includes means for causing the first switch to transition between operating in an on-state of the first switch and an off-state of the first switch.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system for converting power from a power source, in accordance with one or more aspects of the present disclosure.

FIG. 2 is a block diagram illustrating one example of a power converter of the example system shown in FIG. 1.

FIG. 3 is a circuit diagram illustrating an example converter unit for providing a regulated output, in accordance with one or more aspects of the present disclosure.

FIG. 4 is a circuit diagram illustrating an example high-side driver of the example converter unit shown in FIG. 3.

FIG. 5 is a flowchart illustrating example operations of an example power converter, in accordance with one or more aspects of the present disclosure.

FIGS. 6 and 7 are circuit diagrams illustrating additional components of the example converter unit shown in FIG. 3.

FIG. 8 is a circuit diagram illustrating additional components of the example converter unit shown in FIG. 3.

FIGS. 9A-9B are circuit diagrams illustrating examples of a load coupled to a switching node of a half-bridge of the example converter unit shown in FIG. 3.

FIGS. 9C-9E are circuit diagrams illustrating examples of the load shown in FIGS. 9A and 9B.

FIG. 10 is a series of timing diagrams illustrating example operations of the example converter unit shown in FIG. 3.

### DETAILED DESCRIPTION

In some applications, a power converter (hereafter referred to as a “converter”) may convert (e.g., by stepping-up or stepping-down) an input voltage or current from a power source to a regulated output voltage or current for a device (e.g., a load). As described herein, the term “step-up” refers to a power converter configured to receive an input power signal with a first voltage level, and output a power signal with a second voltage level that is greater than the first voltage level. As also described herein, the term “step-down” converter refers to a power converter configured to receive an input power signal with a first voltage level, and output a power signal with a second voltage level that is less than the first voltage level. In either case, a power converter may have a half-bridge that includes one or more switches (e.g., MOS power switch transistors, gallium nitride (GaN) based switches, or other types of switch devices). For example, a half-bridge may include a high-side switch coupled to a low-side switch at a switching node. By controlling the switches of the half-bridge using modulation techniques, the converter can regulate the amount of current or voltage being outputted at an output node that is coupled to the half-bridge. Such modulation of the switches of the half-bridge may operate according to pulse-density-modulation (PDM), pulse-width-modulation (PWM), pulse-frequency-modulation (PFM), or another suitable modulation technique.

Overshoot conditions (e.g., voltage spikes that exceed an expected voltage which is sometimes referred to as “ringing”) may occur at a switch of a half-bridge during a switching event (e.g., when a switch is caused to transition between operating in an on-state or off-state) while providing power to a load. This overshoot condition may be caused by a change in current over time (di/dt) through a switch interacting with one or more parasitic inductances and capacitances. Such parasitic inductances may be caused by one or more connections to the switch transistors. According to one specific example of a step-down/buck converter which is configured to output power with a lower voltage level than receive at the step-down/buck converter input, a voltage overshoot at a switch may reach up to approximately 20V during a switching event for a step-down/buck converter that receives a 12V input voltage. A voltage overshoot may exceed 30V during a switching event when the same step-down/buck converter receives an input voltage of 21V.

To compensate for potential overshoot conditions, some power converters may use switches that can handle the amount of voltage overshoot that may occur across the respective switch of the half-bridge during an overshoot condition. For instance, if a particular half-bridge is configured to switch between zero and 12 volts (V) rather than include switches which are rated to handle 12V, such a power converter may include switches that can handle a voltage level that substantially exceeds an expected voltage level of the half-bridge, such as 25V. Higher rated switch devices are more expensive than lower rated switch devices. As such, converters that have higher rated switch devices to withstand larger overshoot voltages, as a result of high input voltages, may also cost more.

A power converter may be characterized according to an industry de-rating rule. That is, a power converter may use switch devices that have a maximum voltage rating which is some percentage greater than a maximum overshoot voltage that may occur internally to the power converter. For instance, a step-down/buck converter as described above that uses switches that are rated to handle 25V may satisfy an 80% de-rating rule in instances when the input voltage is 12V and the maximum overshoot condition across a switch is 20V (e.g., 25V*80%=20V). To satisfy an 80% de-rating rule, in instances when the input voltage is 21V (e.g., which may be a maximum input voltage used by some power converters, such as for a laptop computer) and a maximum overshoot condition across a switch of the half-bridge exceeds 30V the converter may use switches that are rated to handle at least 35.7V (e.g., 37.5*80%=30V). Again, higher rated switches are more expensive than lower rated switch devices and as such, converters that have higher rated switch devices to not only withstand larger overshoot voltages as a result of high input voltages, and also to satisfy de-rating rules, may also cost more.

In some examples, lower cost converters that satisfy a de-rating rule can be produced by sacrificing efficiency. That is, instead of using higher rated, and often more expensive, switch devices to handle large potential overshoot voltage levels, some converters may prevent potential overshoot conditions by using slow switch transition times (e.g., an increased amount of time to cause a switch to transition between operating in an on-state and an off-state in order to slow down the di/dt through a switch and/or dv/dt across a switch). For example, in the case of a 21V input voltage, a step-down/buck converter may use switch devices with a voltage rating of 30V and prevent a maximum potential overshoot voltage from exceeding 24V (e.g., 30V*80%=24V) using a constant slow switch transition time of the switches.

Constantly using slow switch transition times can reduce a potential overshoot level across a switch of a half-bridge, and as such, the converter can satisfy a de-rating rule up to a maximum defined operating voltage using lower rated, and less expensive, switches. However, constantly using slow switch transition times may unnecessarily reduce the efficiency of the converter when the power converter is operating at voltages lower than a maximum voltage. In some examples, one or more resistors may be used in at least one current path associated with a power source of the gate driver or within the current path between a driver and the gate of a transistor based switch device to slow down the transition time of a switch. With a resistor in between the driver and the gate of the transistor based switch device, both the turn on and turn off times of the switch device are slowed. Rather with a resistor in at least one current path associated with the power source, only either the turn on or turn off of the transistor based switch device. Nevertheless, even with such resistors in the path of the power source of the gate driver or in the current path of the gate of the transistor based switch device, in either case, the converter may still be less efficient than a more costly converter that uses higher rated switch devices and faster transition times of both on to off and off to on transitions.

In general, circuits and techniques of this disclosure may enable a power converter, whether a step-down converter or a step-up converter, to minimize potential voltage overshoots across a switch by shaping the transition time of a switch of the half-bridge based at least in part on detected feedback that indicates one or more voltage levels at the half-bridge, such as at an input of the half-bridge in some examples. The converter may use the voltage at the half-bridge to adjust the “drive strength” of a driver and thereby adjust the amount of time used by a switch to transition between operating in an on-state and an off-state. A higher voltage detected at the half-bridge may cause the converter to decrease the drive strength and thereby increase the transition time of a switch to suppress possible voltage overshoots. A lesser voltage detected at the half-bridge may cause the converter to increase the drive strength and thereby decrease the transition time of the switch when an overshoot condition is less likely occurring or about to occur. By preventing overshoot conditions at a switch of a half-bridge, lower rated and less expensive switches can be used and the efficiency of the power converter may be improved for various different operation voltages.

Rather than using higher rated switch devices, a constant slow switch transition time, and/or extra resistors, to handle overshoot conditions like other power converters, the converter according to the circuits and techniques described herein can satisfy de-rating rules by finely controlling, based on measurements of a voltage at the half-bridge (e.g., a voltage level of a power input in some examples, a voltage level of a power output in some examples), the transition times of the switches of the half-bridge. By shaping the drive strength of the driver and the transition time of a switch based on a detected voltage at a half-bridge, the converter can minimize voltage overshoots across a switch of the half-bridge before an overshoot causes damage to the switches and converter while at the same time providing a highly efficient and low cost power converter solution for a wide range of voltages. The converter according to these circuits and techniques may handle industry de-rating rules without sacrificing cost and/or efficiency.

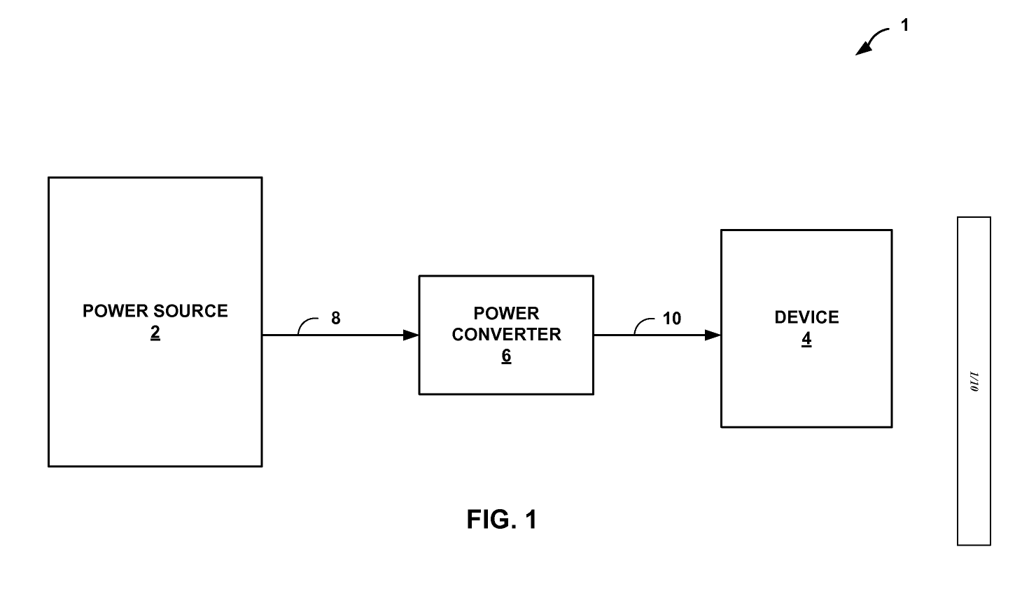

FIG. 1 is a block diagram illustrating system 1 for converting power from power source 2, in accordance with one or more aspects of the present disclosure. FIG. 1 shows system 1 as having three separate and distinct components shown as power source 2, power converter 6, and device 4, however system 1 may include additional or fewer components. For instance, power source 2, power converter 6, and device 4 may be three individual components or may represent a combination of one or more components that provide the functionality of system 1 as described herein.

System 1 includes power source 2 which provides electrical energy in the form of power to system 1. Numerous examples of power source 2 exist and may include, but are not limited to, power grids, generators, power transformers, batteries, solar panels, windmills, degenerative braking systems, hydro electrical generators, or any other form of electrical power devices capable of providing electrical power to system 1.

System 1 includes power converter 6 which operates as a switch-based power converter that converts electrical energy provided by power source 2 into a usable form of electrical power for device 4. Power converter 6 may be a step-up converter that outputs power with a higher voltage level than a voltage level of power received at an input of the step-up converter. One example of such as step-up converter may be referred to as a boost converter. Power converter 6 may instead comprise a step-down converter configured to output power with a lower voltage level than a voltage level of power received at an input of the step-down converter. One example of such a step-down converter may be referred to as a buck converter. In still other examples, power converter 6 may be a step-up and step-down converter (e.g., a buck-boost converter) that is capable of outputting power with a voltage level that is higher or lower level than an input voltage level. Examples of power converter 6 may include battery chargers, microprocessor power supplies, and the like. Power converter 6 may operate as a DC-to-DC, DC-to-AC or AC-to-DC converter. System 1 includes device 4 which receives the electrical power (e.g., voltage, current, etc.) converted by power converter 6 and in some examples, uses the electrical power to perform a function. Numerous examples of device 4 exist and may include, but are not limited to, computing devices and related components, such as microprocessors, electrical components, circuits, laptop computers, desktop computers, tablet computers, mobile phones, batteries, speakers, lighting units, automotive/marine/aerospace/train related components, motors, transformers, or any other type of electrical device and/or circuitry that receives a voltage or a current from a power converter.

Power source 2 may provide electrical power with a first voltage level over link 8 and device 4 may receive electrical power converted by power converter 6 to have a second voltage level over link 10. Links 8 and 10 represent any medium capable of conducting electrical power from one location to another. Examples of links 8 and 10 include, but are not limited to, physical and/or wireless electrical transmission mediums such as electrical wires, electrical traces, conductive gas tubes, twisted wire pairs, and the like. Link 10 provides electrical coupling between power converter 6 and device 4 and link 8 provides electrical coupling between power source 2 and power converter 6. Device 4 is electrically coupled to power converter 6 which is electrically coupled to power source 2.

In the example of system 1, electrical power delivered by power source 2 can be converted to power that has a regulated voltage and/or current level which is suitable for use by device 4. For instance, power source 2 may output, and power converter 6 may receive, power which has a first voltage level at link 8. Power converter 6 may convert the power which has the first voltage level to power which has a second voltage level that is required by device 4. Power converter 6 may output, and device 4 may receive the power that has the second voltage level at link 10. Device 4 may use the power having the second voltage level to perform a function (e.g., power a microprocessor).

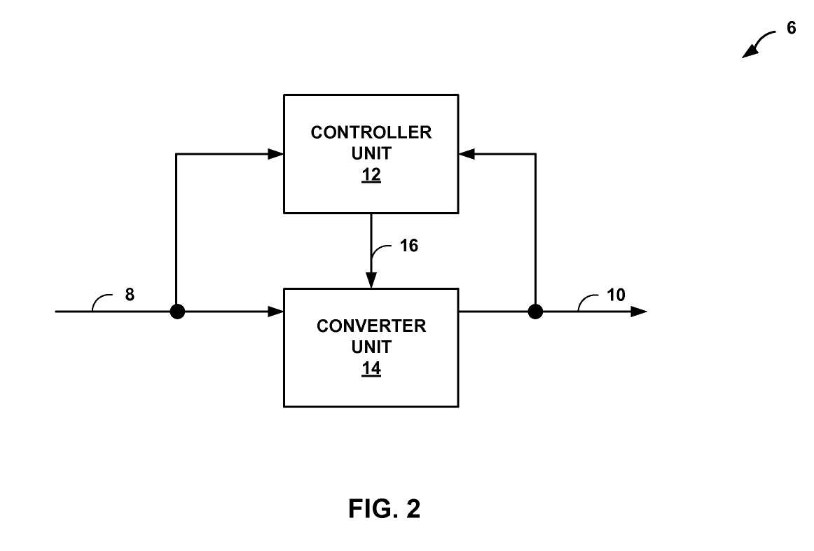

FIG. 2 is a block diagram illustrating one example of power converter 6 of system 1 shown in FIG. 1. For instance, FIG. 2 shows a more detailed exemplary view of power converter 6 of system 1 from FIG. 1 and the electrical connections to power source 2 and device 4 provided by links 8 and 10 respectively.

Power converter 6 is shown as having two electrical components, controller unit 12 and converter unit 14, that power converter 6 uses to convert electrical power that has a certain voltage level and/or current level, to power that has a different voltage level and/or current level. Power converter 6 may include more or fewer electrical components than those shown. For instance, in some examples, controller unit 12 and converter unit 14 are a single semiconductor die, electrical component, or circuit while in other examples, more than two dies, components, and/or circuits provide power converter 6 with the functionality of controller unit 12 and converter unit 14.

Converter unit 14 represents a switched-based power conversion element of power converter 6 that steps-up and/or steps-down a voltage level of power received at an input port coupled to link 8 and provides the power with a stepped-up or stepped-down voltage level as an output at an output port coupled to link 10. Converter unit 14 is described in more detail below, however in general, converter unit 14 may receive power at an input voltage level at a connection (e.g., an input port) coupled to link 8. Converter unit 14 may receive a driver signal or drive command, such as a pulse-density-modulation (PDM) signal, a pulse-width-modulation (PWM) signal, pulse-frequency-modulation (PFM) signal or other suitable modulation technique, from controller unit 12 via link 16 that converter unit 14 uses to convert the received power to provide power at an output voltage level at link 10. The power provided at link 10 may be provided by converter unit 14, based on the driver signal, at a desirable time and with a desirable magnitude (e.g., a voltage level).

Converter unit 14 may include one or more gate drivers, half-bridge circuits, h-bridge circuits, input filters, output filters, or combination thereof to provide an output voltage at link 10 based on power at link 8 and a driver signal at link 16. Converter unit 14 may include one or more switch devices, capacitors, resistors, transistors, transformers, inductors, and/or other electrical components or circuitry that are arranged within converter unit 14 for providing power having a stepped-up or stepped-down voltage level at link 10.

For example, converter unit 14 may include a half-bridge arranged in parallel to an input port of power converter 6 that includes a first switch coupled to a second switch at a switching node. One or more gate drivers may be coupled to the first and/or second switch of the half-bridge and may be configured to control the half-bridge based on a driver signal (e.g., PDM, PWM, PFM, and the like) and a voltage level at the half-bridge. In addition, converter unit 14 may include an output filter arranged between, and coupled to the switching node of the half-bridge and the terminals of an output port at which a load may be coupled to power converter 6 at link 10. The output filter filters and in some cases, averages, the voltage level at the switching node and/or the current that travels between the switching node of the half-bridge and a load coupled to power converter 6 at link 10.

Controller unit 12 of power converter 6 may provide a driver signal to converter unit 14 via link 16 to control at what time and at what magnitude that converter unit 14 provides a power output at link 10. For example, controller unit 12 may generate a modulation signal (e.g., a PWM signal, a PDM signal, a PDM signal, or other modulation signal based on some other modulation technique) based on the voltage level of a power input at link 8 and/or the voltage level of a power output at link 10. In other words, controller unit 12 may provide power converter 6 with a driver signal for controlling the turn-on and/or turn-off signals to the switches of the half-bridge of converter unit 14 to cause converter unit 14 to provide a power output at link 10.

For example, controller unit 12 may provide a PWM signal over link 16 that causes a driver of converter unit 14 to cause a switch of a half-bridge to transition between operating in an on-state and an off state. In response to the voltage level of a power input at link 8 and/or a voltage level of a power output at link 10, controller unit 12 may vary the duty cycle of the PWM signal. By varying the duty cycle of the driver signal, controller unit 12 may alter the magnitude of the voltage level of the power output provided by converter unit 14 at link 10.

In other examples, controller unit 12 may provide a PDM signal over link 16 that causes a driver of converter unit 14 to cause a switch of a half-bridge to transition between operating in an on-state and an off-state. In response to the voltage level of the power input at link 8 and/or the power output at link 10, controller unit 12 may vary the average value of the PDM signal. By varying the average value of the PDM signal, controller unit 12 may alter the magnitude of the voltage level of the power output provided by converter unit 14 at link 10.

Controller unit 12 can comprise any suitable arrangement of hardware, software, firmware, or any combination thereof, to perform the techniques attributed to controller unit 12 herein. For example, controller unit 12 may include digital circuitry, analog circuitry, or any combination thereof to control and regulate a switch mode power converter. Controller unit 12 may include any one or more digital or analog microprocessors, digital signal processors (DSPs), analog signal processors (ASPs), application specific integrated circuits (ASICs), field programmable gate arrays (FPGAs), comparators, operational amplifiers, or any other equivalent, integrated or discrete, digital or analog circuitry, as well as any combinations of such components. When controller unit 12 includes software or firmware, controller unit 12 further includes hardware for storing and executing the software or firmware, such as one or more digital or analog processors or processing units. In general, a processing unit may include one or more digital or analog microprocessors, DSPs, ASPs, ASICs, FPGAs, comparators, operational amplifiers, or any other equivalent, integrated or discrete, digital or analog circuitry, as well as any combinations of such components. Although not shown in FIG. 2, controller unit 12 may include a memory configured to store data. The memory may include any volatile or non-volatile media, such as a random access memory (RAM), read only memory (ROM), non-volatile RAM (NVRAM), electrically erasable programmable ROM (EEPROM), flash memory, and the like. In some examples, the memory may be external to controller unit 12 and/or power converter 6, e.g., may be external to a package in which controller unit 12 and/or power converter 6 is housed.

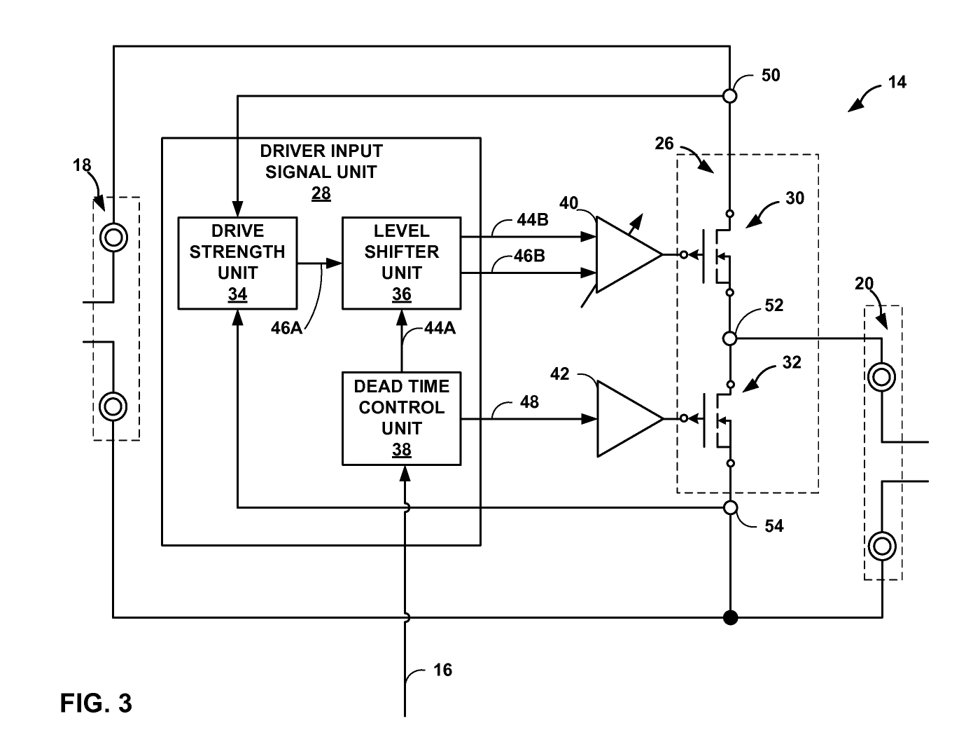

FIG. 3 is a circuit diagram illustrating converter unit 14 for providing a regulated output, in accordance with one or more aspects of the present disclosure. For instance, FIG. 3 shows a more detailed exemplary view of converter unit 14 of power converter 6 from FIG. 2. FIG. 3 is described below within the context of system 1 of FIG. 1.

Converter unit 14 is primarily described below, for purposes of illustration, as providing a power output that has a stepped-down voltage level relative to the voltage level of the power input. It should however be understood that techniques and circuitry described herein with respect to converter unit 14 is also applicable to cases where converter unit 14 provides a power output having a stepped-up voltage level relative to the voltage level of the power input. In other words, converter unit 14 may provide a power output that has a stepped-up voltage level based on the voltage level of a power input and/or a stepped-down voltage level relative to the voltage level of the power input.

Converter unit 14 includes port 18, port 20, half-bridge 26, driver input signal unit 28, driver 40, and driver 42. Half-bridge 26 includes switch 30 coupled to switch 32 at switching node 52. Half-bridge 26 is arranged in parallel to port 18 with a first terminal of switch 30 being coupled to node 50 and a second terminal of switch 32 being coupled to node 54.

Many examples of switch 30 and switch 32 exists and could be any type of switch devices that when arranged in a half-bridge configuration are suitable for stepping-down/bucking or stepping-up/boosting a voltage level of a power input. For instance, some examples of switch 30 and switch 32 may include one or more Silicon (Si), Gallium Nitride (GaN), and/or Silicon Carbide (SiC) based switching device, GaN high-electron-mobility transistors (HEMT), metal-oxide-semiconductor (MOS) based switch devices, field-effect transistors (FET), N-type MOSFET based switch devices, P-type MOSFET based switch devices, diodes, HEMT FETs (GaN), JFETs (SiC, normally on or off), IGBT switch devices, or any other type of power switch transistors or switch device.

In cases when converter unit 14 operates as a step-down/buck converter to provide a stepped-down voltage level, converter unit 14 may receive a power input transmitted across link 8 at port 18 and provide a power output at port 20 and across link 10. Conversely, in cases when converter unit 14 operates as a step-up/boost converter to provide a stepped-up voltage level, converter unit 14 may receive a power input transmitted across link 8 at port 20 and provide a power output at port 18 across and across link 10.

Port 18 includes two terminals coupled to nodes 50 and 54 of converter unit 14. Port 18 may act as a power input port when converter unit 14 operates as a step-down/buck converter, and port 18 may act as a power output port when converter unit 14 operates as a step-up/boost converter. Port 20 includes two terminals with one terminal being coupled to switching node 52 of half-bridge 26 and one terminal coupled to GND at node 54. Port 20 may act as a power output port when converter unit 14 operates as a step-down/buck converter, and port 20 may act as a power input port when converter unit 14 operates as a step-up/boost converter.

In some examples, when port 20 operates as an output port, converter unit 14 may include an output filter at the terminals of port 20. In other words, a filter (e.g., an LC filter) may be arranged between switching node 52 and a terminal of port 20 to average the signal at switching node 52 to create a power output with a stepped-down voltage level at output at port 20. In some examples, when port 18 operates as an output port, converter unit 14 may include an output filter at the terminals of port 18. In other words, an inductive element of a filter (e.g., a capacitor, an LC filter, or some other filter) may be arranged between node 50 and a terminal of port 18, and a capacitive element of the filter may be arranged between node 50 and 54, to average the stepped-up voltage level of a power output at port 18. In addition, when port 18 acts as an output port, an inductive element may be placed at port 20 whether or not a filter is placed at port 18.

Driver 40 and driver 42 are gate drivers for controlling switch 30 and switch 32. Driver 40 is coupled to switch 30 such that an output signal produced by driver 40 may cause switch 30 to transition from operating between an on-state and an off-state. Driver 42 is coupled to switch 32 such that an output signal produced by driver 42 may cause switch 32 to transition from operating between an on-state and an off-state.

Driver input signal unit 28 is described in more detail below, however in general, driver input signal unit 28 is used by converter unit 14 to provide a drive strength signal and a suitable driver signal for causing drivers 40 and 42 to cause switch 30 and switch 32 to turn-on and/or turn-off to control a current level and/or voltage level at switching node 52. In some examples, driver input signal unit 28 and driver 40 and/or driver 42 are a single component of converter unit 14 and reside in the same packaging, on the same die, or within the same electrical component of converter unit 14. Driver input signal unit 28 may include drive strength unit 34, level shifter unit 36, and dead time control unit 38. Driver input signal unit 28 may detect a voltage level at half-bridge 26 (e.g., a potential between nodes 50 and 54) and receive a driver signal via link 16. Driver input signal unit 28 may provide a drive strength signal (based at least in part on the voltage level at half-bridge 26) over link 44B to driver 40. Driver input signal unit 28 may provide a driver signal (based at least in part on the driver signal received over link 16) over link 46B to driver 40 and over link 48 to driver 42. The signals outputted by driver input signal unit 28 via links 44B and 46B may cause driver 40 to cause switch 30 to transition from operating between an on-state and an off-state and the signals outputted by driver input signal unit 28 via link 48 may cause driver 42 to cause switch 32 to transition from operating between an on-state and an off-state.

Level shifter unit 36 represents an optional component or feature of driver input signal unit 28 that may perform level shifting operations to modify driver control signals from driver input signal unit 28 before the driver control signals are sent over links 44B and 46B to driver 40. In other words, level shifter unit 36 may be configured to level shift a driver signal and/or a drive strength signal generated by driver input signal unit 28 prior to outputting the driver signal and/or the drive strength signal to the driver. For instance, level shifter unit 36 may receive a drive strength signal via link 46A having a voltage level that is relative to one ground (e.g., at node 54) that is different from the common mode ground or reference ground that driver 40 uses and which signals typically received by driver 40 are referenced to. Prior to outputting the drive strength signal over link 46B, level shifter unit 36 may convert the drive strength signal to another voltage level that is consistent with the logic used by driver 40. Similarly, level shifter unit 36 may receive a driver signal via link 44A that has a voltage level which is inconsistent with the voltage level of signals received by driver 40 and before outputting the driver signal over link 44B, level shifter unit 36 may convert the driver signal to a voltage level consistent with the logic used by driver 40.

Dead-time control unit 38 may control the timing associated with when driver input signal unit 28 outputs driver signals over links 44B and 48. In some examples, dead-time control 38 may be configured to delay driver signals from passing to driver 40 and driver 42 to prevent driver 40 and driver 42 from causing both switch 30 and switch 32 to operate in the on-state simultaneously, or to at least transition between states at the same time, to prevent half-bridge 26 from being shorted (e.g., to prevent a “shoot-through” condition at half-bridge 26). In other words, dead-time control unit 38 may ensure the correct timing of the components of converter unit 14. For example, dead-time control unit 38 may delay a driver signal associated with driver 40 that may otherwise cause switch 30 to operate in an on-state until an amount of time has passed to allow driver 42 to cause switch 32 to transition from operating in an on-state to an off-state.

Drive strength unit 34 may detect a voltage level at half-bridge 26 (e.g., a voltage level of a power input or power output at port 18), and based on the detected voltage, produce a “drive strength signal” used by driver 40 for adjusting the transition time needed for switch 30 to transition between operating in an on-state and an off-state. In other words, drive strength unit 34 may be configured to generate a drive strength signal used by driver 40 that modifies the transition time associated with switch 30 based at least in part on the voltage at half-bridge 26. When converter unit 14 operates as a step-down/buck converter, drive strength unit 34 may be configured to generate a drive strength signal used by driver 40 that modifies the transition time associated with switch 30 based at least in part on the voltage level of a power input at port 18. When converter unit 14 operates as a step-up/boost converter, drive strength unit 34 may be configured to generate a drive strength signal used by driver 40 that modifies the transition time associated with switch 30 based at least in part on the stepped-up voltage level of a power output at port 18.

The drive strength signal may affect the amount of current that driver 40 uses in driving switch 30 to cause switch 30 to transition between operating in an on-state and an off-state. Driver 40 may use more current to drive switch 30 with an increased level of drive strength and may use less current to drive switch 30 with a decreased level of drive strength. The drive strength signal may be a logical signal that driver 40 receives over link 46B that alters the transition time of switch 30 when driver 40 causes switch 30 to “turn-on” or “turn-off”. The drive strength signal may be a linear signal, a digital signal, an analog signal, or a group of digital or analog signals that include two or more discreet levels or states.

By altering the transition time according to a drive strength that is based on the voltage at half-bridge 26, converter unit 14 may suppress an amount of voltage across switch 32 prior to or during a potential overshoot condition when switch 30 is being turned-on when current is flowing between switching node 52 and a load coupled to port 20 or when current is flowing between node 50 and a load coupled to port 18.

Driver input signal unit 28 may output a drive strength signal, based on the voltage at half-bridge 26, to driver 40 so that driver 40 can shape or control the transition strength of driver 40. Said differently, driver 40 can use the drive strength signal output from driver input signal unit 28 to alter the amount of time needed for switch 30 to transition from operating in an on-state and an-off state. By shaping the transition time of switch 30, driver 40 can finely control switch 30 to prevent or handle voltage overshoots that may potentially or are occurring at half-bridge 26. In other words, the drive strength signal that is based on the voltage at half-bridge 26 may provide converter unit 14 with the capability to limit or prevent voltage ringing across one or more of switches 30 and 32 of half-bridge 26 from reaching potentially damaging levels and ensure that switches 30 and 32 of half-bridge 26 operate in accordance with the respective voltage ratings of switches 30 and 32.

For example, drive strength unit 34 may determine the voltage level at half-bridge 26 and may generate a drive strength signal associated with switch 30 based on the voltage level. The drive strength signal outputted by drive strength unit 34 over link 46A may have a particular logic level that is approximately proportionate to the detected voltage level at half-bridge 26. For instance, drive strength unit 34 may produce a zero or low level drive strength signal if the voltage at half-bridge 26 is less than a maximum voltage that converter unit 14 can safely handle at port 18 based on the voltage ratings of switch 30 and switch 32 and a given de-rating rule (e.g., 80%).

Conversely, drive strength unit 34 may produce a greater than zero or high level drive strength signal if the voltage level detected at half-bridge 26 approaches or exceeds the expected voltage limit that converter unit 14 can safely handle according to the rating level of switch 30 and switch 32 and a particular de-rating rule. In other words, the drive strength signal may have a low value (e.g., one) if the voltage at half-bridge 26 or switching node 52 is less than an expected voltage and may have a high value (e.g., greater than one) if the voltage is equal to or exceeds the expected voltage (e.g., in the case of changes of the voltage level at half-bridge 26).

In some examples, the expected voltage at half-bridge 26 may be less than twenty-one volts if thirty volt switch devices are used as switch 30 and switch 32 and converter unit 14 satisfies an 80% de-rating rule. In other examples, the expected voltage may be less than or equal to twenty volts if twenty-five volt switch devices are used as high-side switch 30 and low-side switch 32 and converter unit 14 satisfies an 80% de-rating rule. Drive strength unit 34 may produce a drive strength signal that can cause driver 40 to increase or decrease the transition time associated with switch 30 by an amount of time that is approximately proportionate to the detected voltage. Using the drive strength signal, driver input signal unit 28 and driver 40 may cause switch 30 to have slower transition times as the detected voltage increases to suppress overshoots. Driver input signal unit 28 and driver 40 may cause switch 30 to have faster transition times when the detected voltage at half-bridge 26 indicates that a potential voltage ringing level across switches 30 and 32 may remain within the bounds of the ratings including de-rating rules of switches 30 and 32.

Driver input signal unit 28 may receive (e.g., from controller unit 12) a driver signal (e.g., PDM signal, PWM signal, PFM signal and the like) over link 16 for controlling, switch 30 and switch 32. Dead time control unit 38 may generate a driver signal for controlling switch 30 at link 44A based on the driver signal received over link 16 and may further generate a driver signal for controlling switch 32 at link 48 based on the driver signal received over link 16. In other words, controller unit 12 may produce a driver signal for controlling half-bridge 26 and dead-time control 38 may delay driver control signals which are based at least in part on the driver signal to control the timing of converter unit 14 so that only one of switches 30 and 32 is operating in an on-state at any one time.

Driver 42 may receive the driver signal generated by dead-time control 38 at link 48. Driver 42 may control switch 32 based on the driver signal to cause switch 32 to operate in an on-state or an off-state. Driver 40 may receive a level shifted driver signal generated by dead-time control 38 and level shifter unit 36 via link 44B as well as a level-shifted drive strength signal generated by drive strength unit 34 and level shifter unit 36 via link 46B. The drive strength signal received by driver 40 may be based on, and indicative of, the voltage level at half-bridge 26.

Driver 40 may control switch 30, and driver 42 may control switch 32, based on the received driver signal and drive strength signal to control the signal at switch node 52. Driver 40 may cause switch 30 to transition between operating in an off-state and an on-state with an amount of time that is based on the input voltage (e.g., which is indicated by the drive strength signal) and further based on a driver signal at link 44B while driver 42 may cause switch 32 to transition between operating in an off-state and an on-state based on the received driver signal. In this way, driver 40 and driver 42 can prevent impending or handle actual overvoltage conditions at half-bridge 26 (e.g., across one or more of switches 30 and 32) when converter unit 14 provides power to a load coupled to port 18 or port 20 all while maintaining a high efficiency rating over a wide range of operating voltages being applied at half-bridge 26.

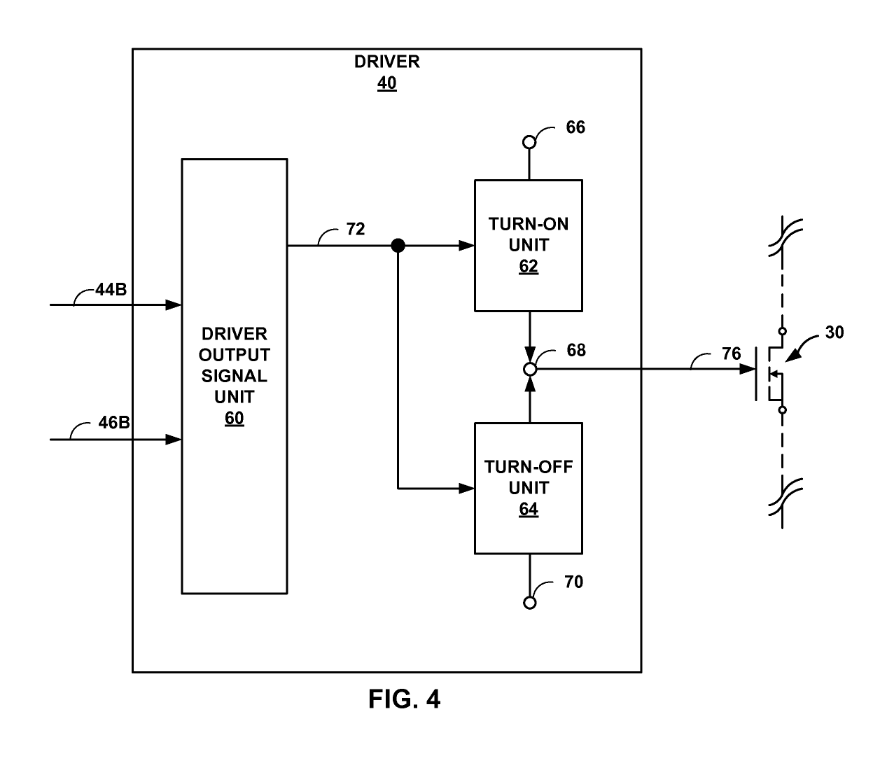

FIG. 4 is a circuit diagram illustrating a more detailed view of driver 40 of converter unit 14 shown in FIG. 3. FIG. 4 is described below within the context of converter unit 14 of FIG. 3, system 1 of FIG. 1, and power converter 6 of FIG. 2. FIG. 4 illustrates only one example of driver 40 and other examples of driver 40 are described below with respect to the additional figures.

Driver 40 of FIG. 4 includes driver output signal unit 60, turn-off unit 64, and turn-on unit 62. Driver output signal unit 60 of driver 40 is coupled to links 44B and 46B for receiving a driver signal and a drive strength signal from driver input signal unit 28. Driver 40 is coupled to switch 30 at node 68. Driver output signal unit 60 of driver 40 may cause driver 40 to output a current passed from turn-on unit 62 and/or turn-off unit 64 over link 76 that causes switch 30 to “turn-on” or “turn-off”. Based on the drive strength signal and the driver signal received from driver input signal unit 28, driver output signal unit 60 may provide commands or signals over link 72 to control turn-on unit 62 and turn-off unit 64. Driver output signal unit 60 may send commands or signals over link 72 to enable turn-on unit 62 to pull the voltage level at node 68 up to the voltage level at node 66 (e.g., VCC) or to disable turn-on unit 62 and enable turn-off unit 64 to pull the voltage level at node 68 down to the voltage level at node 70 (e.g., VEE).

For purposes of illustration, techniques and circuitry of driver 40 are described below as if switch 30 is a NMOS switch device. It should be understood however that similar circuitry and techniques may be used by driver 40 to drive switch 30 if switch 30 is a PMOS switch device. In the case when switch 30 is a PMOS switch device, the connections to VCC and VEE are reversed. In other words, when switch 30 is a PMOS switch device, driver output signal unit 60 may send commands or signals over link 72 to enable turn-on unit 62 to pull the voltage level at node 68 down to the voltage level at node 66 (e.g., VEE) or to disable turn-on unit 62 and enable turn-off unit 64 to pull the voltage level at node 68 up to the voltage level at node 70 (e.g., VCC).

Turn-on unit 62 and turn-off unit 64 may be a combination of any one or more variable voltage sources, variable current sources, variable resistors, switch devices, op-amps, or other electrical circuits or components that can be controlled by driver 40 to provide a variable level output voltage at node 68 and/or variable current level through link 76 in accordance with the techniques and circuitry described herein. Turn-on unit 62 and turn-off unit 64 may be individual electrical circuits or components or may be a single electrical circuit or component of driver 40 of FIG. 4. For example, turn-on unit 62 and turn-off unit 64 may be variable resistor elements.

Driver output signal unit 60 can send commands over link 72 to individually control the internal resistances of turn-on unit 62 and turn-off unit 64 thereby effecting how fast the gate of transistor 30 is charged. Turn-on unit 62 and turn-off unit 64 may be variable voltage sources and/or variable current sources and driver output signal unit 60 may send commands over link 72 to individually control the amount of current and/or voltage that each of turn-on unit 62 and turn-off unit 64 provide across link 76. Turn-on unit 62 and turn-off unit 64 may be an arrangement of switch devices or transistors and driver output signal unit 60 can send commands over link 72 to individually turn-on or turn-off individual switch devices or transistors to control the amount of current that each of turn-on unit 62 and turn-off unit 64 provide across link 76 and/or to control the resistance between node 66 (e.g., VCC) and node 68 and node 70 (e.g., VEE). In some examples, the functionality of turn-on unit 62 and turn-off unit 64 may be performed by a single op-amp that is configured to act as a voltage and/or current shape generator. Driver output signal unit 60 may send commands (e.g., a signal at a particular voltage and/or current level) over link 72 to the current and/or voltage shape generator. In response to the signal or command received over link 72, the op-amp may cause the the voltage at node 68 and the amount of current outputted at link 76 to change.

Driver 40 of FIG. 4 may receive a drive strength signal via link 46B that driver input signal unit 28 generates based on a voltage at half-bridge 26. In addition to the drive strength signal, driver 40 may receive a driver signal via link 44B that driver input signal unit 28 outputs based on, and in response to, a driver signal (e.g., PDM, PWM, PFM, and the like) received via link 16. Based on the logic level of the driver signal received via link 44B, driver output signal unit 60 may cause switch 30 to operate in either an on-state or an off-state. To cause switch 30 to operate in an on-state, driver output signal unit 60 may send a command over link 72 to disable turn-off unit 64 and to enable turn-on unit 62 to pull the voltage level at node 68 to the voltage level at node 66 (e.g., VCC). To cause switch 30 to operate in an off-state, driver output signal unit 60 may send a command over link 72 to disable turn-on unit 62 and to enable turn-off unit 64 to pull the voltage level at node 68 to the voltage level at node 70 (e.g., VEE).

Using the drive strength signal received over link 46B, driver output signal unit 60 can actively change the variable resistance, current, or voltage of turn-on unit 62 or turn-off unit 64 over the time of the turn-on and turn-off transition to better shape the transition of switch 30. For example, driver output signal unit 60 can cause the variable resistance, current, or voltage of turn-on unit 62 or turn-off unit 64 over the time of the turn-on and turn-off transition time in order to better control the voltage at node 68 and/or the current at link 76. . By finely controlling or shaping the voltage at node 68 and the amount of current that reaches switch 30, driver 40 can control the transition time of switch 30. In other words, driver 40 can control the amount of time for switch 30 to transition from operating in an on-state and an off-state based on the voltage at half-bridge 26. By shaping the voltage at node 68 and the current level at link 76, driver 40 can prevent possible overshoot conditions from occurring at switch 30 and switch 32.

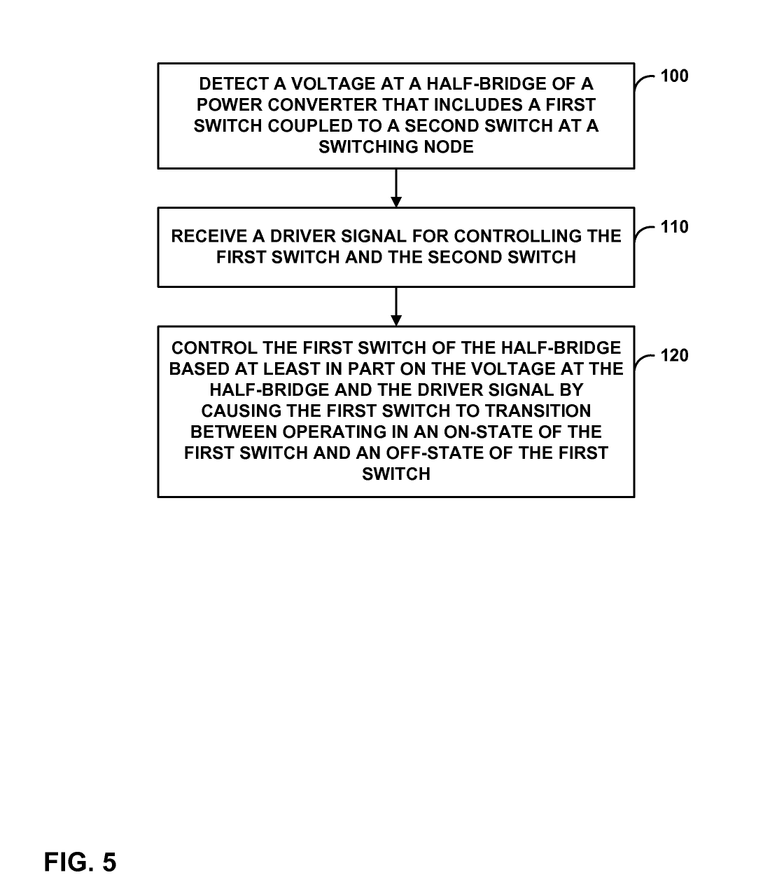

FIG. 5 is a flowchart illustrating example operations of an example power converter, in accordance with one or more aspects of the present disclosure. FIG. 5 is described below within the context of converter unit 14 of FIG. 3, system 1 of FIG. 1, and power converter 6 of FIG. 2.

Power converter 6 may detect a voltage at a half-bridge that includes a first switch coupled to a second switch at a switching node (100). For example, power source 2 may apply power at link 8 of system 1 that power converter 6 receives as a power input at port 18 of converter unit 14 when converter unit 14 operates as a step-down/buck converter with an filter at port 20, or at port 20 of converter unit 14 when converter unit 14 operates as a step-up/boost converter with a filter at port 18 and an inductive element at port 20. Drive strength unit 34 of driver input signal unit 28 may detect a voltage level at half-bridge 26 and generate a drive strength signal based on the voltage level at the half-bridge at link 46A.

Power converter 6 may receive a driver signal for controlling the first switch and the second switch (110). For example, controller unit 12 of power converter 6 may apply a PDM, PWM, PFM, or other suitable driver signal to link 16 that converter unit 14 may use to provide a power output that has a stepped-down voltage level or a stepped-up voltage level. Driver input signal unit 28 may receive the driver signal and, based on the PDM, PWM, PFM or other suitable driver signal, produce driver signals at links 44B and 48 for driver 40 and driver 42 to control, respectively, switch 30 and switch 32. In other words, controller unit 12 may provide driver signals to converter unit 14 and to cause converter unit 14 to either step-down or step-up the voltage level of a power input from power source 2 to a particular voltage level of a power output for device 4.

Power converter 6 may control the first switch of the half-bridge based at least in part on the voltage at the half-bridge and the driver signal by causing the first switch to transition between operating in an on-state of the first switch and an off-state of the first switch (120). For example, driver 40 may receive a drive strength signal that drive strength unit 34 provides at link 46B and is based at least in part on the voltage at half-bridge 26. In addition, driver 40 may receive a level shifted and/or dead-time delayed driver signal at link 44B that driver input signal unit 28 produces based on the driver signal received over link 16. Driver 40 may cause switch 30 to transition between operating in an on-state and an off-state based at least in part on the driver signal received over link 44B and the drive strength signal received over link 46B which is indicative of the voltage at half-bridge 26. Driver 40 may cause switch 30 to transition from an off-state to an on-state when the driver signal indicates that switch 30 should be turned on and from an on-state to an off-state when the driver signal indicates that switch 30 should be turned off. Driver 40 may cause the transition of switch 30 to either the on-state or off-state to occur over an amount of time that corresponds to the drive strength indicated by the drive strength signal. Said differently, rather than cause switch 30 to immediately turn-on or turn-off, driver 40 may adjust the transition time of switch 30 based on the voltage at half-bridge 26.

In some examples, the operations performed by power converter 6 may further include modifying an amount of time for the first switch to transition between operating in the off-state of the switch and the on-state of the switch based at least in part on the voltage at the half-bridge 26 (e.g., the voltage level of a power input in the case of a step-down/buck converter or the voltage level of a power output for a step-up/boost converter). For example, driver 40 may output a lesser amount of current or a lesser voltage to switch 30 to increase the amount of time for switch 30 to transition between operating in the off-state and the on-state based on the drive strength signal received over link 46B to cause the transition time to increase. In other words, driver 40 may slow-down the transition time of switch 30 based on a potential overshoot voltage across a switch indicated by the voltage at half-bridge 26. Conversely, driver 40 may output a greater amount of current or a greater voltage to switch 30 to decrease the amount of time for switch 30 to transition between operating in the off-state and the on-state based on the drive strength signal received over link 46B to cause the transition time to decrease. In other words, driver 40 may speed-up the transition time of switch 30 when the possibility that an overshoot voltage across a switch is less likely, as may be indicated by the voltage at half-bridge 26.

In some examples, the operations performed by power converter 6 may further include detecting the possibility of an overshoot condition across a switch by determining the voltage at the half-bridge and increasing the amount of time based on the possibility of the overshoot condition detected at the half-bridge. For example, drive strength unit 34 may compare the voltage at half-bridge 26 to an expected voltage level. If the voltage at half-bridge 26 exceeds an expected voltage level by at least one threshold, drive strength unit 34 may determine that an overshoot condition is occurring or is about to occur. For instance, if the expected voltage is 12V and the voltage measured at half-bridge 26 exceeds 20V, then drive strength unit 34 may determine that an overshoot condition is occurring or is about to occur at half-bridge 26 and may decrease the drive strength provided to driver 40, thereby increasing the transition time of switch 30 and further decreasing efficiency of power converter 6.

In some examples, the operations performed by power converter 6 may further include detecting a relatively lower risk of the possibility of an overshoot condition over a switch by determining the voltage at the half-bridge and decreasing the amount of time based on the relatively lower risk of the possibility of the overshoot condition detected at the half-bridge. For example, drive strength unit 34 may compare the voltage at half-bridge 26 to an expected voltage level. If the voltage at half-bridge 26 does not exceed an expected voltage level by at least one threshold, drive strength unit 34 may determine that an overshoot condition is not occurring or is not likely to occur at half-bridge 26. For instance, if the expected voltage is 12V and the voltage determined at half-bridge 26 is approximately 15V, then drive strength unit 34 may determine that an overshoot condition is not occurring or is not likely to occur at half-bridge 26 and may increase the drive strength provided to driver 40, thereby decreasing the transition time of switch 30 and further increasing efficiency of power converter 6.

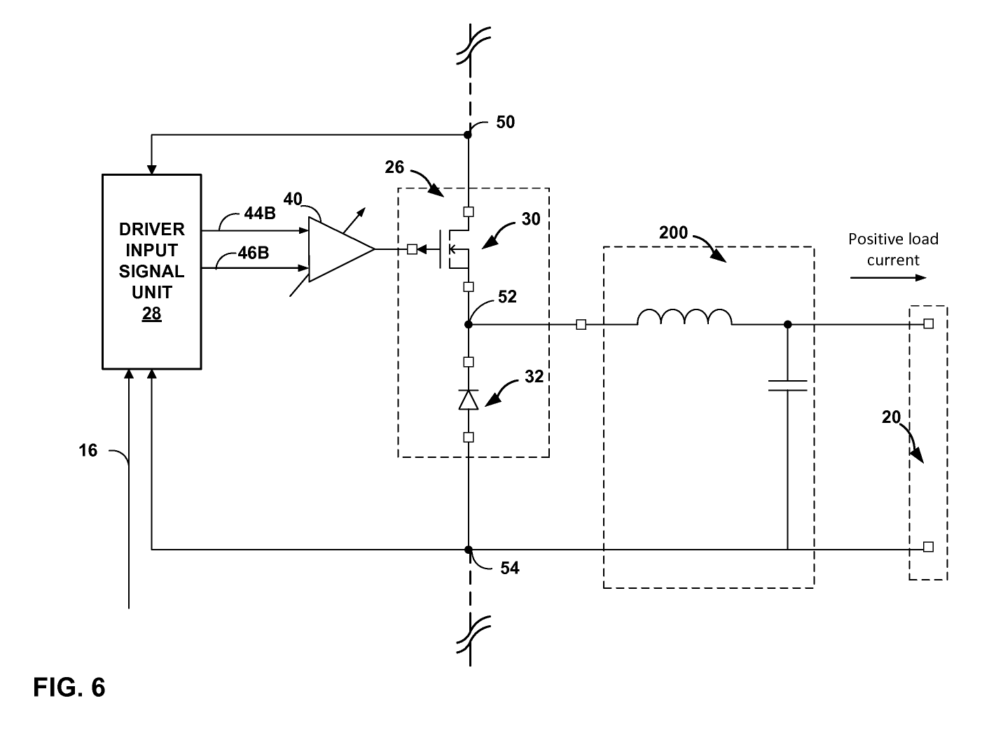

FIGS. 6 and 7 are circuit diagrams illustrating additional components of converter unit 14 shown in FIG. 3. FIGS. 6 and 7 are described below within the context of converter unit 14 of FIG. 3, system 1 of FIG. 1, and power converter 6 of FIG. 2. FIGS. 6 and 7 illustrates example step-down/buck converters for outputting power that has a stepped-down DC or AC voltage level at port 20 based on an power input received at nodes 50 and 54 that has a higher DC voltage level.

In the example of FIG. 6, half-bridge 26 includes a diode as switch 32 (e.g., a low-side switch of half-bridge 26) to illustrate that many examples of half-bridges and combinations and arrangements of switch 30 and switch 32 may be used by converter unit 14. In addition, FIG. 6 further illustrates LC output filter 200 coupled to switching node 52 and arranged in series between switching node 52 and output port 20 to produce a positive load current that travels through a load coupled to port 20. Driver 40 may receive a drive strength signal and a driver signal via links 46B and 44B from driver input signal unit 28 for controlling when and the amount of time that a high-side switch (e.g., switch 30) transitions from an off-state to an on-state (or from an on-state to an off-state) when load currents travel through a load at port 20 to prevent possible overshoots that may occur or are occurring at a low-side switch (e.g., switch 32).

In the example of FIG. 7, half-bridge 26 includes a diode as switch 30 (e.g., a high-side switch of half-bridge 26) to illustrate that many examples of half-bridges and combinations and arrangements of switch 30 and switch 32 may be used by converter unit 14. Like FIG. 6, FIG. 7 further illustrates LC output filter 200 coupled to switching node 52 and arranged in series between switching node 52 and port 20 and a load current that travels through the load coupled to port 20. Switch 30 in the example of FIG. 7 is a diode and driver 40 is coupled to switch 32 (e.g., a low-side switch of half-bridge 36) to illustrate that just like a high-side switch of a half-bridge, driver 40 may receive a drive strength signal and a driver signal via links 46B and 44B from driver input signal unit 28 for controlling a low-side switch of a half-bridge according to the techniques described herein. Driver 40 may receive driver signals that driver 40 uses to control when and the amount of time that a low-side switch (e.g., switch 32) transitions from an off-state to an on-state when positive load currents travel through a load to prevent possible overshoots or handle actual overshoots that may occur or are occurring at a high-side switch (e.g., switch 30).

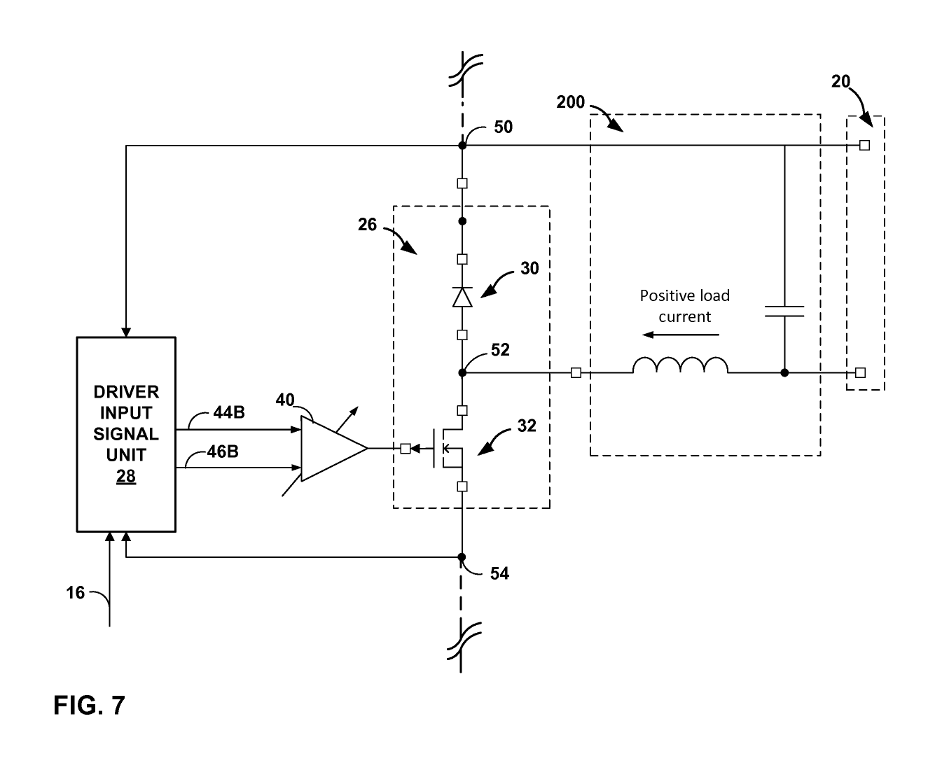

FIG. 8 is a circuit diagram illustrating additional components of converter unit 14 shown in FIG. 3. FIG. 8 is described below within the context of converter unit 14 of FIG. 3, system 1 of FIG. 1, and power converter 6 of FIG. 2. FIG. 8 illustrates an example step-up/boost converter for outputting a stepped-up/boosted DC voltage at port 18 which in this example, acts as an output port coupled to nodes 50 and 54 to provide a power output that has a stepped-up voltage level which is based on a lesser AC or DC voltage level of a power input received at port 20. Port 20, in this case, being an input port coupled to switching node 52.

In the example of FIG. 8, half-bridge 26 includes inductor 210 arranged in series between one of the terminals of port 20 and switching node 52 and also includes capacitor 212 arranged in parallel between the terminals of port 18. In addition, FIG. 8 further illustrates driver 42 being configured similarly to driver 40 for receiving a drive strength signal for controlling the transition time for switch 32 to transition from operating in an on-state and an off-state. Driver 42 may receive a drive strength signal via link 46C which is based on the voltage at half-bridge 26 that driver input signal unit 28 detects at nodes 50 and 54. Driver 42 may control switch 32 and may be coupled to the switch 32 and be configured to cause switch 32 to transition between operating in an on-state of switch 32 and an off-state of switch 32 based on the driver signal received over link 48 and the drive strength signal received over link 46C that is indicative of the voltage at half-bridge 26. Driver 40 and driver 42 may control the amount of time that both high-side switch (e.g., switch 30) and low-side switch (e.g., switch 32) transition from off-states to on-states and from on-states to off-states based on a voltage at half-bridge 26 to prevent possible overshoots that may occur or are occurring at either low-side switch (e.g., switch 32) or high-side switch (e.g., switch 30).

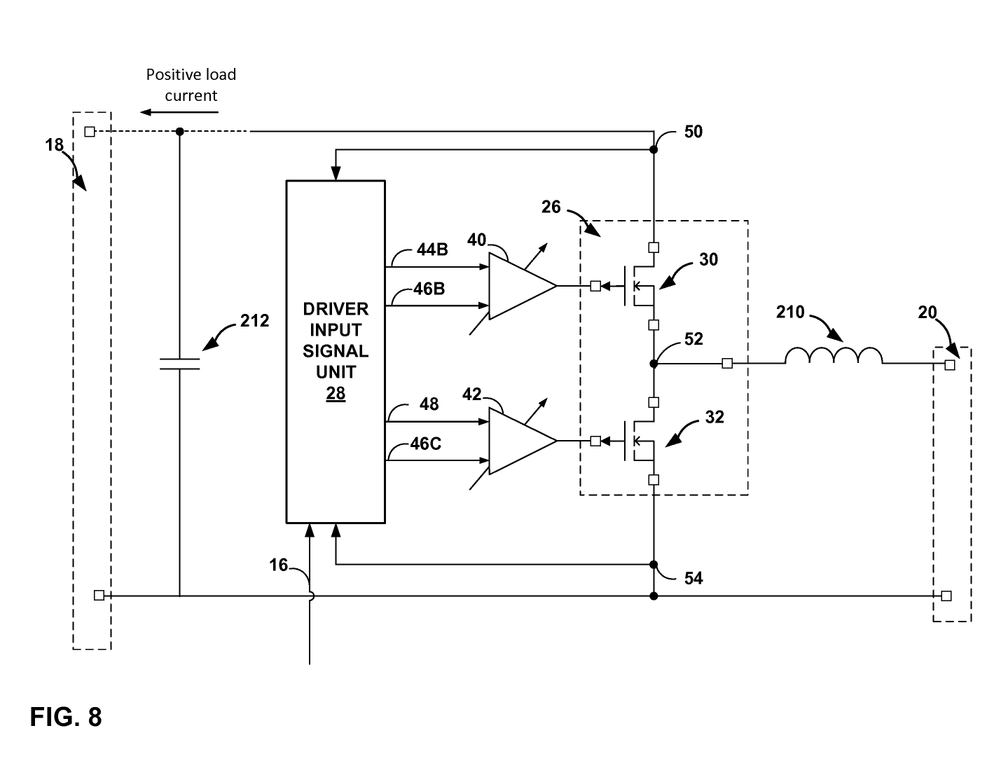

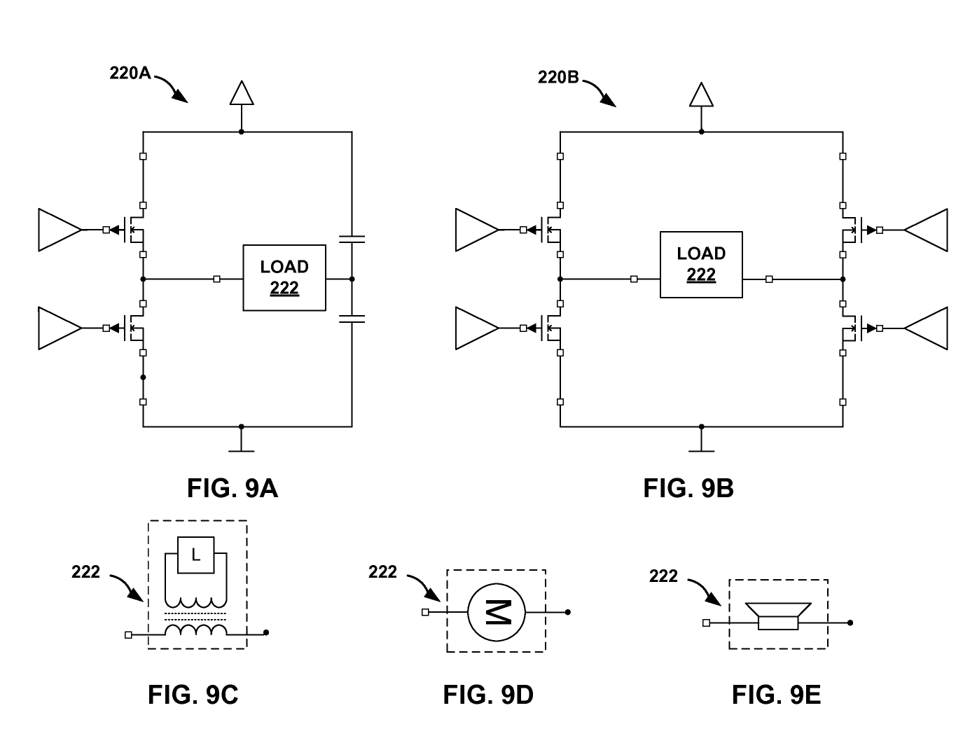

FIGS. 9A-9B are circuit diagrams illustrating examples of load 222 coupled to a switching node of a half-bridge of the example converter unit shown in FIG. 3. FIGS. 9A-9B are described below within the context of system 1 of FIG. 1 and power converter 6 of FIG. 2.

FIG. 9A shows system 220A as having two drivers, one driver being used to control a high-side switch and a second driver being used to control a low-side switch, the high-side switch and the low-side switch are coupled together at a switching node of a half-bridge. FIG. 9A further shows that load 222 is coupled to the switching node of the half-bridge. A current may travel between load 222 and the switching node of system 220A. In accordance with the techniques and circuits described herein, each of the drivers of system 220A may control the amount of time that both the high-side switch of system 220A and the low-side switch of system 220A transition from off-states to on-states and from on-states to off-states based on a voltage at the half-bridge of system 220A when currents travel between the switching node of system 220A and load 222 to prevent overshoots that may occur at either the low-side switch of system 220A or the high-side switch of system 220A.

FIG. 9B shows system 220B which includes an h-bridge coupled to load 222. The h-bridge of system 220B is made of two half-bridge circuits that are coupled to load 222 at each of their respective switching nodes. In other words, the h-bridge of system 220B includes a first and second driver for controlling, respectively, a first switch coupled to a second switch at a first switching node of a first half-bridge and a third and fourth driver for controlling a third switch coupled to a fourth switch at a second switching node of a second half-bridge. The first and second switching nodes of the h-bridge of system 220B form an output port. A first terminal of the output port corresponds to the first switching node and a second terminal of the output port corresponds to the second switching node. Load 222 is coupled to both the first switching node of the first half-bridge and the second switching node of the second half-bridge at the first and second terminals of the output port. A current may travel between load 222 and the first switching node of system 220B and may further travel between load 222 and the second switching node of system 220B.

In accordance with the techniques and circuits described herein, the drivers of the first half-bridge of system 220B may control the amount of time that both the first switch of system 220B and the second switch of system 220B transition from off-states to on-states and from on-states to off-states based on a voltage at the first half-bridge of system 220B when currents travel between the first switching node of system 220B and load 222 to prevent overshoots that may occur at either the first switch of system 220B or the second switch of system 220B. Alternatively or additionally, in accordance with the techniques and circuits described herein, the drivers of the second half-bridge of system 220B may control the amount of time that both the third switch of system 220B and the fourth switch of system 220B transition from off-states to on-states and from on-states to off-states based on a voltage at the second half-bridge of system 220B when currents travel between the second switching node of system 220B and load 222 to prevent overshoots that may occur at either the third switch of system 220B or the fourth switch of system 220B.

FIGS. 9C-9E are circuit diagrams illustrating examples of load 222 shown in FIGS. 9A and 9B. FIGS. 9C-9E are each described within the context of system 220A of FIG. 9A. FIGS. 9C-9E represent only some examples of load 222 and many other examples of load 222 exist. For instance, examples of load 222 include at least all the examples of device 4 described with respect to system 1 of FIG. 1. In addition, loads 222 can contain further filtering elements (e.g., inductors, capacitors, etc.) that are not shown.

FIG. 9C illustrates load 222 as being a load coupled to a secondary side winding of a transformer which has a primary side winding coupled to the switching node of system 220A. The primary winding of the transformer may receive an alternating voltage and current as the drivers of system 220A operate in accordance with the techniques described herein to control the signal at the switching node of system 220A to provide power to the load at the secondary side of the transformer. For example, the drivers of system 220A may control the amount of time that both the high-side switch of system 220A and the low-side switch of system 220A transition from off-states to on-states and from on-states to off-states based on a voltage at the half-bridge of system 220A when currents travel between the switching node of system 220A and load 222 to prevent overshoots that may occur at either the low-side switch of system 220A or the high-side switch of system 220A.

FIG. 9D illustrates load 222 as being a motor coupled to the switching node of system 220A. The motor may receive a current as the drivers of system 220A operate in accordance with the techniques described herein to modulate the signal at the switching node of system 220A to control the motor. For examples, the drivers of system 220A may control the amount of time that both the high-side switch of system 220A and the low-side switch of system 220A transition from off-states to on-states and from on-states to off-states based on a voltage at the half-bridge of system 220A when currents travel between the switching node of system 220A and load 222 to prevent overshoots that may occur at either the low-side switch of system 220A or the high-side switch of system 220A.

FIG. 9E illustrates load 222 as being a speaker coupled to the switching node of system 220A. The speaker may receive a current as the drivers of system 220A operate in accordance with the techniques described herein to modulate the signal at the switching node of system 220A to control the speaker. For examples, the drivers of system 220A may control the amount of time that both the high-side switch of system 220A and the low-side switch of system 220A transition from off-states to on-states and from on-states to off-states based on a voltage at the half-bridge of system 220A when currents travel between the switching node of system 220A and load 222 to prevent overshoots that may occur at either the low-side switch of system 220A or the high-side switch of system 220A.

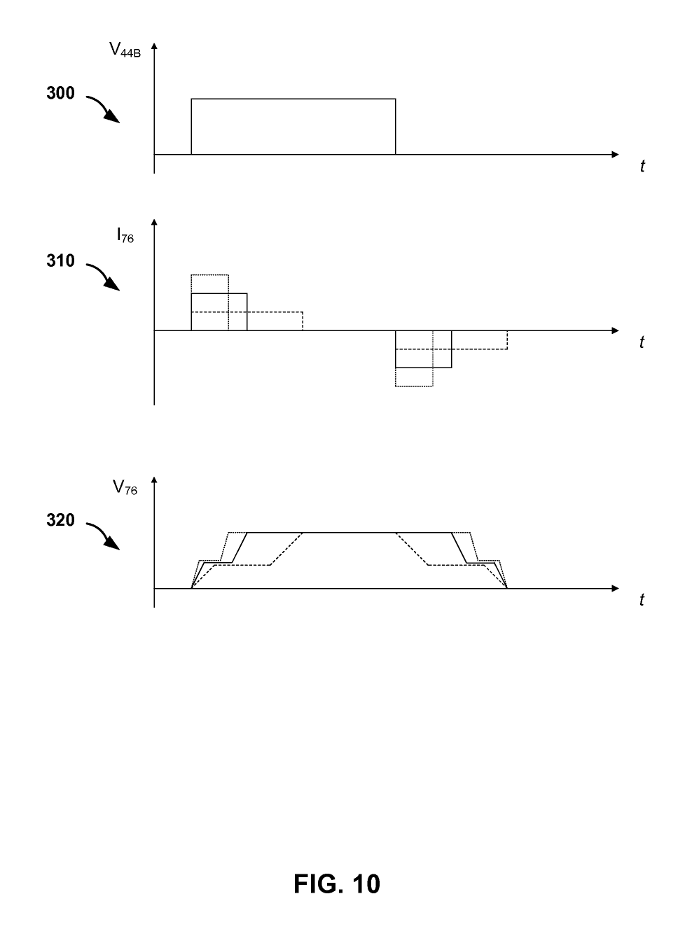

FIG. 10 is a series of timing diagrams illustrating example operations of the example converter unit shown in FIG. 3. FIG. 10 is described below within the context of system 1 of FIG. 1, power converter 6 of FIG. 2, converter unit 14 of FIG. 3, and driver 40 of FIG. 4.

FIG. 10 shows 4 plot 300, plot 310, and plot 320. Plot 300 corresponds to a voltage at link 44B of FIG. 4 as driver 40 receives a driver signal based on a driver signal received by converter unit 14 from controller unit 12. Plot 300 shows the driver signal as a single pulse received over time and is indicative of a command from controller unit 12 to cause driver 40 to cause switch 30 to transition from an off-state of switch 30 to an on-state.

Plot 310 shows the current over time at link 76 between node 68 of driver 40 and switch 30 of FIG. 4. Plot 310 shows that driver 40 may cause the shape of the current across link 76 for driving switch 30 to be shaped in accordance with driver 40 operating as one or more ideal current sources. Plot 320 shows an alternate example of the gate voltage over time at node 68 of driver 40 (e.g., the gate of switch 30) of FIG. 4.

In some examples, the operations performed by power converter 6 may further include causing the first switch to operate in the on-state for a first amount of time, and causing the first switch to operate in the off-state for a second amount. The first and second amounts of time may be based on a ratio between the first and second amounts of time, the ratio being defined by the driver signal. For example, the driver signal provided by controller unit 12 may be based on modulation techniques used to cycle switch 30 and switch 32 to produce a PDM, PWM, PFM or other modulated signal at switching node 52. The driver signal may be at one logic level for a certain amount of time to cause driver 40 to transition switch 30 to an on-state for that amount of time. The driver signal may be at a different logic level for a different amount of time to cause driver 40 to transition switch 30 to an off-state for that different amount of time. In some examples, the amount of time that driver 40 causes switch 40 remain on and off may be defined by a ratio indicated by the driver signal received over link 16. Driver 42 may similarly cause switch 32 to cycle between an on-state of switch 32 and an off-state of switch 32, however when switch 32 is being cycled to the on-state, driver 40 may be cycling switch 30 to the off-state, and vice versa.

In some examples, the operations performed by power converter 6 may further include controlling the second switch of the half-bridge based at least in part on the voltage at the half-bridge and the driver signal by at least causing the second switch to transition between operating in an on-state of the second switch and an off-state of the second switch. For instance, as driver 40 is causing switch 30 to cycle between the on-state of switch 30 and the off-state of switch 30 based at least in part on the voltage at half-bridge 26 and the driver signal received over link 16, driver 42 may also be causing switch 32 to cycle between the off-state and the on-state based at least in part on the driver signal received over link 16 and in some examples, also based on a drive strength signal that driver input signal unit 28 derives based on the voltage at half-bridge 26. In some examples, dead time control unit 38 may ensure correct timing of converter unit 14 to ensure drivers 40 and 42 do not simultaneously receive the same logic level driver signal to prevent both switches 30 and 32 from both operating in an on-state.

In some examples, a power converter comprises a half-bridge that includes a first switch coupled to a second switch at a switching node; and a driver for controlling the first switch, wherein the driver is coupled to the first switch and configured to cause the first switch to transition between operating in an on-state of the first switch and an off-state of the first switch based at least in part on a driver signal and a voltage at the half-bridge. In some examples, the power converter comprises a buck converter, and wherein the voltage at the half bridge comprises an input voltage of the half bridge. In some examples, the power converter comprises a boost converter, and wherein the voltage at the half bridge comprises an output voltage of the half bridge.

In some examples, the driver of the power converter is further configured to modify an amount of time for the first switch to transition between operating in the off-state of the switch and the on-state of the switch, wherein the amount of time is based at least in part on the voltage at the half-bridge. In some examples, the driver of the power converter is further configured to increase the amount of time if the voltage at the half-bridge exceeds at least one threshold . In some examples, the driver of the power converter is further configured to decrease the amount of time if the voltage at the half-bridge does not exceed a threshold. In some examples, the driver of the power converter is further configured to modify the amount of time based at least in part on the voltage at the half-bridge in response to a change in the voltage at the half-bridge. In some examples, the driver of the power converter is further configured to cause the first switch to operate in the on-state for a first amount of time, wherein the driver is further configured to cause the first switch to operate in the off-state for a second amount of time, and wherein the first and second amounts of time are based on a ratio between the first and second amounts of time, the ratio being defined by the driver signal.

In some examples, the first switch of the power converter is a high-side switch of the half-bridge and the second switch is a low-side switch of the half-bridge. In some examples, the first switch of the power converter is a switch transistor and the second switch is a diode. In some examples, the driver signal of the power converter comprises at least one of a pulse-density-modulation signal, a pulse width modulation signal, and a pulse frequency modulation signal.

In some examples, the driver of the power converter is a first driver, and the power converter further comprises a second driver for controlling the second switch, wherein the second driver is coupled to the second switch and configured to cause the second switch to transition between operating in an on-state of the second switch and an off-state of the second switch based on the driver signal and the voltage at the half-bridge. In some examples, the half-bridge of the power converter is a first half-bridge and the power converter further comprises an output port for connecting a load; and an h-bridge that includes the first half-bridge coupled to a second half-bridge at the output port, wherein the second half-bridge includes a third switch coupled to a fourth switch at a second switching node, wherein a first terminal of the output port is coupled to the first switching node and a second terminal of the output port is coupled to the second switching node.

In some examples, a method comprises detecting a voltage at a half-bridge of a power converter, wherein the half-bridge includes a first switch coupled to a second switch at a switching node; receiving a driver signal for controlling the first switch and the second switch; and controlling the first switch of the half-bridge based at least in part on the voltage at the half-bridge and the driver signal, wherein controlling the first switch includes causing the first switch to transition between operating in an on-state of the first switch and an off-state of the first switch. In some examples, the method further comprises modifying an amount of time for the first switch to transition between operating in the off-state of the switch and the on-state of the switch based at least in part on input voltage at the half-bridge.

In some examples, the method further comprises comparing the voltage to at least one threshold, and increasing the amount of time for the first switch to transition between operating in the off-state of the switch and the on-state of the switch if the voltage at the half-bridge exceeds the at least one threshold. In some examples, the method further comprises comparing the voltage to a threshold, and decreasing the amount of time for the first switch to transition between operating in the off-state of the switch and the on-state of the switch if the voltage at the half-bridge does not exceed the threshold.

In some examples, the method further comprises causing the first switch to operate in the on-state for a first amount of time; and causing the first switch to operate in the off-state for a second amount, wherein the first and second amounts of time are based on a ratio between the first and second amounts of time, the ratio being defined by the driver signal.

In some examples, the method further comprises controlling the second switch of the half-bridge based at least in part on the voltage at the half-bridge and the driver signal, wherein controlling the second switch includes causing the second switch to transition between operating in an on-state of the second switch and an off-state of the second switch.

In some examples, a power converter comprises means for detecting a voltage at a half-bridge of the power converter, wherein the half-bridge includes a first switch coupled to a second switch at a switching node; means for receiving a driver signal for controlling the first switch and the second switch; and means for controlling the first switch of the half-bridge based at least in part on the voltage at the half-bridge and the driver signal, wherein the means for controlling the first switch includes means for causing the first switch to transition between operating in an on-state of the first switch and an off-state of the first switch.

The techniques of this disclosure may be implemented in a wide variety of devices or apparatuses, including an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A power converter comprising:
a half-bridge that includes a first switch coupled to a second switch at a switching node; and
a driver for controlling the first switch, wherein the driver is coupled to the first switch and configured to cause the first switch to transition between operating in an on-state of the first switch and an off-state of the first switch based at least in part on a driver signal and a voltage at the half-bridge.

2. The power converter of claim 1, wherein the power converter comprises a buck converter, and wherein the voltage at the half bridge comprises an input voltage of the half bridge.

3. The power converter of claim 1, wherein the power converter comprises a boost converter, and wherein the voltage at the half bridge comprises an output voltage of the half bridge.

4. The power converter of claim 1, wherein the driver is further configured to modify an amount of time for the first switch to transition between operating in the off-state of the switch and the on-state of the switch, wherein the amount of time is based at least in part on the voltage at the half-bridge.

5. The power converter of claim 4, wherein the driver is further configured to increase the amount of time if the voltage at the half-bridge exceeds at least one threshold.

6. The power converter of claim 4, wherein the driver is further configured to decrease the amount of time if the voltage at the half-bridge does not exceed a threshold.

7. The power converter of claim 4, wherein the driver is further configured to modify the amount of time based at least in part on the voltage at the half-bridge in response to a change in the voltage at the half-bridge.

8. The power converter of claim 4, wherein the driver is further configured to cause the first switch to operate in the on-state for a first amount of time, wherein the driver is further configured to cause the first switch to operate in the off-state for a second amount of time, and wherein the first and second amounts of time are based on a ratio between the first and second amounts of time, the ratio being defined by the driver signal.

9. The power converter of claim 1, wherein the first switch is a high-side switch of the half-bridge and the second switch is a low-side switch of the half-bridge.

10. The power converter of claim 1, wherein the first switch is a switch transistor and the second switch is a diode.

11. The power converter of claim 1, the driver signal comprises at least one of a pulse-density-modulation signal, a pulse width modulation signal, and a pulse frequency modulation signal.

12. The power converter of claim 1, wherein the driver is a first driver, the power converter further comprising:
a second driver for controlling the second switch, wherein the second driver is coupled to the second switch and configured to cause the second switch to transition between operating in an on-state of the second switch and an off-state of the second switch based on the driver signal and the voltage at the half-bridge.

13. The power converter of claim 1, wherein the half-bridge is a first half-bridge, the power converter further comprising:
an output port for connecting a load; and
an h-bridge that includes the first half-bridge coupled to a second half-bridge at the output port, wherein the second half-bridge includes a third switch coupled to a fourth switch at a second switching node, wherein a first terminal of the output port is coupled to the first switching node and a second terminal of the output port is coupled to the second switching node.

14. A method comprising:
detecting a voltage at a half-bridge of a power converter, wherein the half-bridge includes a first switch coupled to a second switch at a switching node;
receiving a driver signal for controlling the first switch and the second switch; and
controlling the first switch of the half-bridge based at least in part on the voltage at the half-bridge and the driver signal, wherein controlling the first switch includes causing the first switch to transition between operating in an on-state of the first switch and an off-state of the first switch.

15. The method of claim 14, further comprising:
modifying an amount of time for the first switch to transition between operating in the off-state of the switch and the on-state of the switch based at least in part on the voltage at the half-bridge.

16. The method of claim 15, further comprising:
comparing the voltage to at least one threshold; and
increasing the amount of time for the first switch to transition between operating in the off-state of the switch and the on-state of the switch if the voltage at the half-bridge exceeds the at least one threshold.

17. The method of claim 15, further comprising:
comparing the voltage to a threshold; and
decreasing the amount of time for the first switch to transition between operating in the off-state of the switch and the on-state of the switch if the voltage at the half-bridge does not exceed the threshold.

18. The method of claim 14, further comprising:
causing the first switch to operate in the on-state for a first amount of time; and
causing the first switch to operate in the off-state for a second amount, wherein the first and second amounts of time are based on a ratio between the first and second amounts of time, the ratio being defined by the driver signal.

19. The method of claim 14, further comprising:
controlling the second switch of the half-bridge based at least in part on the voltage at the half-bridge and the driver signal, wherein controlling the second switch includes causing the second switch to transition between operating in an on-state of the second switch and an off-state of the second switch.

20. A power converter comprising:
means for detecting a voltage at a half-bridge of the power converter, wherein the half-bridge includes a first switch coupled to a second switch at a switching node;
means for receiving a driver signal for controlling the first switch and the second switch; and
means for controlling the first switch of the half-bridge based at least in part on the voltage at the half-bridge and the driver signal, wherein the means for controlling the first switch includes means for causing the first switch to transition between operating in an on-state of the first switch and an off-state of the first switch.
